(19) United States
(12) Patent Application Publication
(10) Pub. No.: US 2011/0295754 A1
(43) Pub. Date: Dec. 1, 2011

(54) Prioritization for product management

(76) Inventor: Samer Mohamed, Nasr City (EG)

(21) Appl. No.: 13/118,408

(22) Filed: May 28, 2011

(30) Foreign Application Priority Data
Jun. 1, 2010 (EP) EP10164631

(51) Int. Cl. G06Q 10/00

(52) U.S. Cl. 705/300

(57) ABSTRACT

Systems and methods of prioritizing requirements for product release are disclosed. An exemplary method comprises receiving customer satisfaction requirements for a pending product release. The method also comprises receiving product manager input for the pending product release to meet a release schedule on time and on budget. The method also comprises receiving developer business requirements for the product release to balance the business desires of the developer. The method also comprises processing the received customer satisfaction requirements, product manager input, and developer business requirements for the pending product release to prioritize requirements and increase or maximize value for the customer and the developer and increase overall satisfaction with when the product is released.

### PRIORITY CLAIM

This application claims priority to European Patent No. EP10164631, filed 1 Jun. 2010, hereby incorporated by reference as though fully set forth herein.

### BACKGROUND

Due to increasing requirements for market-driven products, there is a corresponding need for methods capable of prioritizing and selecting the most important requirements before product release. Because not all of the requirements can be met with available time and resource parameters in one, or even several product releases, many product managers believe that it is not only important to enable their customers to assign priorities to requirements and to make decisions about them, but also to provide their customers with alternative solutions. Accordingly, the product managers can provide more value for their customers through selecting the most highly desired requirements to be implemented in each of the product releases.

Managing these requirements becomes a key factor that results not only in the product success or failure, but also the customer satisfaction with the product. An important aspect of this process is to identify those requirements that balance the customer's needs, expectations, business value, total cost, and scheduling of the product release.

Value-Oriented Prioritization (VOP) is a process which seeks to align product demand with the product organization goals and customer expectations by prioritizing and managing requirements over the product life cycle. VOP helps provide an overall view for the sake of the product organization targets and vision, rather than arguing over which product requirements to implement.

VOP focuses on the core business values that lead to customer satisfaction while prioritizing the product requirements. Exemplary core business values include the customer value gained from implementing the requirement, the implementation cost, risk associated with implementing the requirement, impact if this requirement is not implemented, and other market-related aspects that may be affected if the requirement is not implemented. Each business value is weighted based on the stakeholders objectives and vision. Requirement attractiveness is proportional to the value it provides and inversely proportional to its cost, associated risk, impact and other market aspects.

Hierarchical Cumulative Voting (HCV), is another process which uses a ratio-scale prioritization technique. HCV was designed to overcome the drawbacks for Analytical Hierarchy Protocol (AHP) and Cumulative. Voting (CV) techniques. HCV provides relative priorities based on a ratio scale, and determines the importance of a set of requirements by adding together the relative priorities. The main concept with HCV is to quantify the requirement importance by distributing points between the requirements to reflect this importance. However, when prioritizing with HCV, not all requirements are prioritized at the same time. Instead, prioritizations are performed at different levels of the hierarchy, and within different blocks of the requirements in the hierarchy. Accordingly, the requirements are distributed over two levels of the hierarchy: high-level requirements (HLR) and low-level requirements (LLR). The relationship between the lower-level requirements are OR relationships among themselves. Only those requirements within the same block are prioritized at the same time.

### BRIEF DESCRIPTION OF THE DRAWINGS

FIG. 1 is a high-level illustration of an exemplary architecture which supports a value based product management framework.

FIG. 2a is a diagram illustrating difficulty of modification factors.

FIG. 2b is a diagram illustrating difficulty of creation factors.

FIG. 3 is a high-level illustration of an exemplary HBMIA architecture.

FIG. 4 is a high-level illustration of an exemplary value point counting process architecture.

FIG. 5 is an illustration of an exemplary window showing edit input data to the framework.

FIG. 6 is an illustration of an exemplary window showing edit prioritization options.

FIG. 7 is an illustration of an exemplary window showing stakeholder satisfaction.

### DETAILED DESCRIPTION

Meeting stakeholders requirements and expectations becomes an important aspect of many product releases (e.g., software, although the disclosure herein is not limited to any particular type of product). Therefore, systems and methods are described herein for prioritizing requirements for product release. Prioritizing requirements, or “requirements prioritization,” as used herein refers to identifying and increasing or even maximizing customer satisfaction with a product release (e.g., by including those components which are most important to the customer), while balancing the business desires of the product stakeholder (e.g., meeting a release schedule on time and on budget).

Briefly, systems and methods may be implemented for prioritizing requirements for product release. In exemplary embodiments, customer satisfaction requirements are received for a pending product release. Product manager input is used for the pending product release to meet a release schedule on time and on budget. Developer business requirements are also used for the product release to balance the business desires of the developer. The customer satisfaction requirements, product manager input, and developer business requirements for the pending product release are then used to output prioritized requirements.

The systems and methods may implement one or more of approaches to prioritize requirements. In exemplary embodiments, Value-Oriented Hierarchical Cumulative Voting HCV (VOHCV), Hybrid-Based Maintainability Impact Analysis (HBMIA), Value Point (VP), and Value-Oriented Requirements Management (VORM) techniques may be employed. The techniques described herein can be used in selecting the most value-add requirements for each product release, based not only on the perceived value to the customer and the developer, but also in terms of associated anticipated cost, technical risk, relative impact, and other market-related aspects. The techniques described also support both flat structures and hierarchical structures. Accordingly, the techniques described herein may be utilized to select the best release requirements, maximize value for both the customer and the developer, minimize product risks, minimize implementation effort, minimize impacts on existing system components, and increase overall customer satisfaction with the product.

Before continuing, it is noted that the operations described herein may be embodied as logic instructions on one or more computer-readable medium. When executed on a processor, the logic instructions cause a general purpose computing device to be programmed as a special-purpose machine that implements the described operations. In an exemplary implementation, the components and connections depicted in the figures may be used. It is also noted, however, that the operations are not limited to those shown and described, nor are the operations limited to any particular order.

### Exemplary Architecture

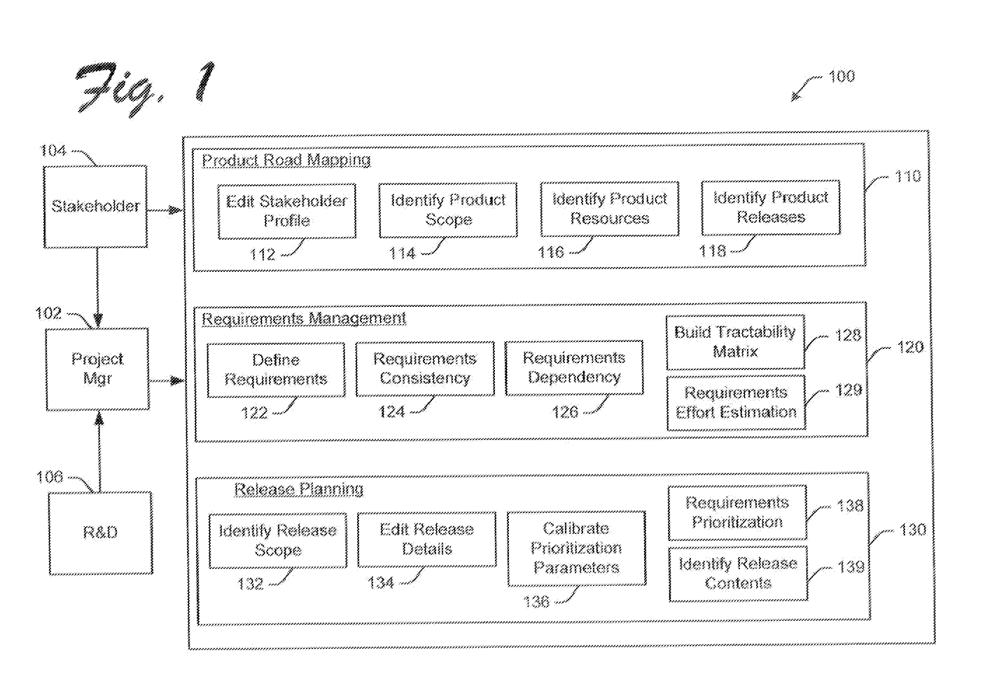

FIG. 1 is a high-level illustration of an exemplary architecture 100 which supports a value based product management framework. It is noted that the architecture 100 shown in FIG. 1 is merely exemplary of one embodiment, and other embodiments may also become apparent to those having ordinary skill in the art after becoming familiar with the teachings herein.

The architecture 100 is based on artifacts of a product management hierarchy. That is, each product has a release cycle that includes past, current and future releases. Each release includes a group of selected requirements identified based on the customer and/or developer (also referred to collectively or individually, herein as, “stakeholders”) values for each requirement. These values reflect the importance of each requirement in terms of anticipated cost, technical risk, relative impact, perceived importance, and other market-related aspects, to name only a few examples. The basic building block for each release is the requirement which adds a technical or functional value to the product. As indicated in FIG. 1, the architecture 100 includes three layers for the product management hierarchy. Each layer is described in more detail below.

The product road mapping module 110 layer focuses on the product high level processes. The product manager (PM) 102 initially edits the stakeholders profiles and assigns a weight for each one on a scale from 1 to 9 based on the importance of the stakeholder to the project (e.g., stakeholders 104 may be ranked higher if they have a high impact on the outcome; and stakeholders 104 may be ranked lower if they have a lower impact on the outcome). Once the profile is enabled for each stakeholder 104, the stakeholder 104 can make entries for one or more product requirement. These entries are received by the “requirements identification” and “requirements prioritization” processes. The stakeholder requirements may be used to define the product scope. Based on the product scope, the product resources required to implement the product can be defined. And based on the product scope and product resources, the different product releases for product completion can be identified.

The requirements management module 120 includes processes that affect the product requirements over the product lifecycle. For example, product requirements from different stakeholders 104 (e.g., to reflect customer-driven objectives), and from research and development (R&D) 106 (to reflect technology-driven objectives) may be input by the project manager 102. The stakeholders 104 enter values for each requirement (e.g., based on the stakeholders' perception of each requirement). For example, the stakeholder may enter values for cost, value, risk, impact, and other market-related aspects. The values may be assigned a weighting (e.g., from 1 to 9; such that 9 indicates higher importance, and 1 indicates lower importance to the stakeholder 104). The requirements may then be analyzed for consistency. Any consistency violations (e.g., start and end implementation dates, unique identifiers, allocated resources) are identified for review/correction. A valid list of requirements is then examined for correlation between the different requirements.

The correlated list of requirements is then input to a “build tractability matrix” process. This process is responsible for building different links between the requirement and implementation modules/components. The requirements list at this phase reflects the actual product objectives. Thus the product manager 102 is able to estimate the effort required for each requirement, so that the product manager 102 can efficiently allocate product resources through the release planning module 130.

It is noted that the architecture 100 may implement a number of analysis for prioritization for product management. The product mapping module 110 may implement a VOHCV analysis via operations 112-118. The requirements management module 120 may implement a HBMIA analysis and a VP analysis via operations 122-129. The release planning module 130 may implement a VORM analysis via operations 132-139. These operations may be better understood with reference to the following more detailed description of each of these analyses below.

### A. Value-Oriented Hierarchical Cumulative Voting (VOHCV)

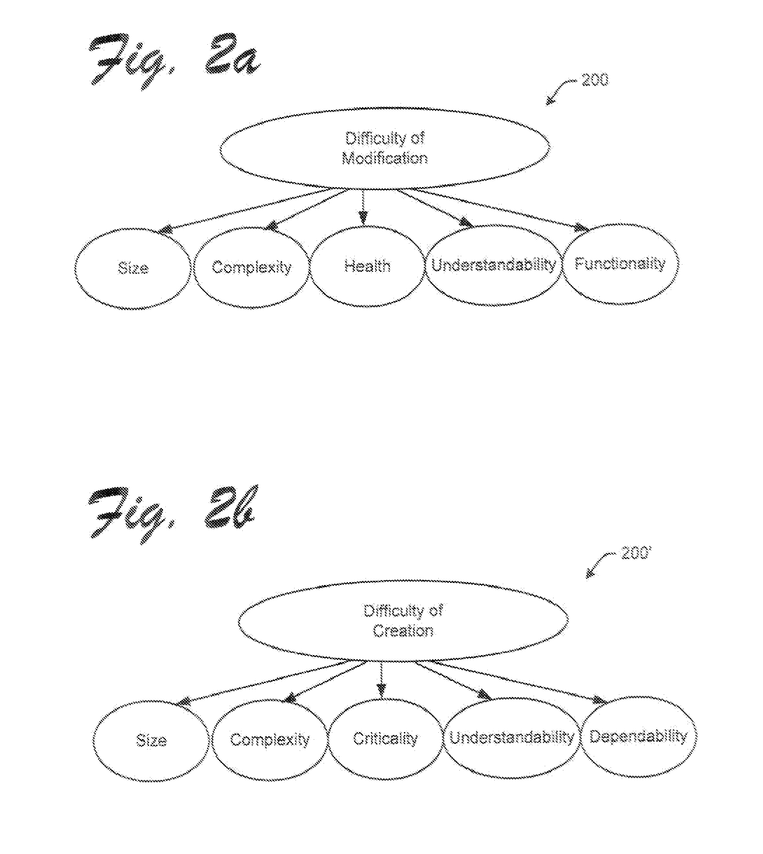

FIG. 2a illustrates difficulty of modification factors 200. FIG. 2b illustrates difficulty of creation factors 200′. VOHCV may handle requirements prioritization. The core business values are assigned global weights. The supported business values for each requirement in VOHCV may include the anticipated implementation cost, associated implementation risk, perceived customer value, relative impact and market-related aspects. The weights may be assigned based on the product organization strategic goals and/or future vision for the product and/or the organization.

The weights for each business value feature are assigned. These weights reflect how much each feature is important to the stakeholders. In an exemplary embodiment, these weights may be common to all stakeholders sharing in the requirements prioritization process. These weights may range from 1 to 10, where a weight of 1 reflects lower importance and a weight, of 10 reflects higher importance.

Each stakeholder may offer input for each business value feature (e.g., costs, risks, impacts, and market-related aspects) in terms of feature value. This input may reflect how a feature may affect the requirement from the stakeholder's perspective. In an exemplary embodiment, all business values discussed above have different features, except the business value, which has only one feature. These values may range from 1 to 10, where a value of 1 reflects lower importance and a value of 10 reflects higher importance.

The requirement distribution points assigned to each requirement may be determined based on the feature weights and values. This may be done by each stakeholder sharing in the requirements prioritization process. In an exemplary embodiment, the distribution-points may be determined using the following parameters:
Wc: Weight for the global (Cost) business value.
Wv: Weight for the global (Value) business value.
Wr: Weight for the global (Risk) business value.
Wi: Weight for the global (Impact) business value.
Wa: Weight for the global (Aspect) business value.
Wi,j: Weight assigned to requirement (Ri) with respect to business value feature (Fj).
Vi,j: Value assigned to requirement (Ri) with respect to business value feature (Fj).
Nc: Count of features per (Cost) business value.
Nr: Count of features per (Risk) business value.
Ni: Count of features per (Impact) business value.
Na: Count of features per (Aspect) business value.
Nb: Count of business values that affect requirement.
CBVavr: Average value for the (Cost) business value affect requirement.
RBVavr: Average value for the (Risk) business value affect requirement.
IBVavr: Average value for the (Impact) business value affect requirement.
ABVavr: Average value for the (Aspect) business value affect requirement.
TNdist: Total distribution number for the requirement.
ANdist: Average distribution number for the requirement.
Cf: Compensation factor to control the range of the distribution number. It may be set to 10 to have the distribution number range between 1 and 100 similar to ordinary HCV.
R_Pt: Number of points assigned to each requirement.

The average distribution number for each requirement can be determined as follows. First, the average business value is determined for each requirement. The average value for the (Cost) business value is given by the following equation:

CBVavr=(SUMWijXVij)/Nc (EQN 1A)

The average value for the (Risk) business value is given by the following equation:

RBVavr=(SUMWijXVij)/Nr (EQN 2A)

The average value for the (Impact) business value is given by the following equation:

IBVavr=(SUMWijXVij)/Ni (EQN 3A)

The average value for the (Aspect) business value is given by the following equation:

ABVavr=(SUMWijXVij)/Na (EQN 4A)

The total distribution number for each, requirement is determined, as given by the following equation:

TNdist=WcXCBVavr+WrXRBVavr+WiXIBVavr+WaXABVavr+WvXVij (EQN 5A)

The average distribution number assigned to each requirement is determined (and is also referred to herein as the “assigned priority”). The average distribution number is given by the following equation:

ANdist=TNdist/(NbXCf) (EQN 6A)

The distribution number between the different LLRs of the same HLRs to have the sum of all the LLRs points equals 100 as indicated by CV technique is determined. This may be determined by using the relation between the LLRs distribution numbers and the following equation:

ΣR_{—}Pt=100 (EQN 7A)

The intermediate priorities for the requirements is determined, either through the “straight” or “compensated” analysis. The intermediate priority may be determined using the following parameters and equation:
Pi,LLR_u: Intermediate priority value for the Lower Level Requirement (LLR) (u).
Pa,LLR_u: Assigned priority value for the Lower Level Requirement (LLR) (u) determined previously.
Pa,HLR_v: Assigned priority value for the Higher Level Requirement (HLR) (v), or the parent of LLR_u.
CHLR_v: Block specific compensation factor, this could be the number of requirements within the prioritization block.

Pi,LLR_{—}u=CHLR_{—}vXPa,LLR_{—}uXPa,HLR_{—}v (EQN 8A)

The final priorities are determined for the requirements at the level of interest. The determination may be performed across the blocks within the same level. This indicates that all requirements located at this specific, level may be prioritized relative to each other. The final priority may be determined using the following parameters and equation:
Pf,LLR_u: Final priority value for the Lower Level Requirement (LLR) (u).
Pi,LLR_k: Intermediate priority value for all the Lower Level Requirement (LLR) (k) of the (H LR_v).

Pf,LLR_{—}u=Pi,LLR_{—}u/ΣPi,LLR_{—}k (EQN 9A)

The final priorities are determined based on the consolidated stakeholders weighted priorities determined above. The final priority may be determined using the following parameters and equation:
Pmf,LLR_u: Final priority value for all stakeholders of the Lower Level Requirement (LLR) (u).
Pf,LLR_u,S_k: Final priority value for stakeholders (S_k) of the Lower Level Requirement (LLR) (u).
Wk: Stakeholder normalized weight.

Pmf,LLR_{—}u=ΣWkXPf,LLR_{—}u,S_{—}k (EQN 10A)

The final ranks may be determined based on the final priority value assigned to each requirement.

### Example A-1

For purposes of illustrating the VOHCV analysis, the following example is provided based on the requirement hierarchy structure. In this example, there are two abstraction levels and one stakeholder. Furthermore there are two high-level requirements, (HLRs) and five low-level requirement (LLRs). Given the business value weights, features weights and features values for each requirement from Table A1, the requirements may be determined by following the VOHCV analysis described in more detail above.

The number of points assigned to each requirement of the same block is determined, or by other means distribute 100 points over the requirements of the same block.

TABLE A1
Input values and weights

| | Business value | | | | | | | |
|---|---|---|---|---|---|---|---|---|
| | Cost | | Risk | | Impact | Aspect | | Value |
| | B.V. Weight | | | | | | | |
| | 9 | | 10 | | 6 | 4 | | 5 |
| Feature type | C1 | C2 | R1 | R2 | I1 | A1 | A2 | V1 |
| F. Weight | 5 | 8 | 10 | 6 | 3 | 7 | 8 | 10 |
| HLR1(Value) | 3 | 4 | 5 | 3 | 1 | 1 | 5 | 2 |
| HLR2(Value) | 9 | 6 | 6 | 8 | 9 | 10 | 3 | 7 |
| LLR1(Value) | 1 | 10 | 10 | 7 | 2 | 5 | 9 | 4 |
| LLR2(Value) | 8 | 10 | 9 | 10 | 10 | 8 | 9 | 10 |
| LLR3(Value) | 3 | 5 | 6 | 5 | 4 | 3 | 2 | 10 |
| LLR4(Value) | 1 | 2 | 2 | 4 | 3 | 2 | 4 | 3 |
| LLR5(Value) | 9 | 8 | 10 | 7 | 9 | 10 | 9 | 10 |

This can be accomplished by applying equations 1A through 7A, given the values and weights of Table A1. These points are illustrated in the first two columns in Table A2, below. After all of the requirements in the prioritization blocks have been assigned priorities, the intermediate LLR priority using equation 8A may be determined given that the compensation factor is equivalent to the block size as illustrated in the third column of Table A2. The intermediate LLR priority is illustrated in the fourth column of Table A2.

The final normalized LLR priority is determined using equation 9A. The final LLR priority is illustrated in the fifth column of Table A2. The LLRs may be ranked based on the final LLR priority. The LLR rank priority is illustrated in the sixth column of Table A2.

TABLE A2
VOHCV Requirements output ranks

| HLR/LLR | HLR | LLR | Compensation | Intermediate | Final | Rank |
|---|---|---|---|---|---|---|
| HLR1/LLR | 30 | 40 | 2 | 2400 | 9 | 5 |
| HLR1/LLR | 30 | 60 | 2 | 3600 | 13 | 3 |
| HLR2/LLR | 70 | 33 | 3 | 6930 | 26 | 2 |
| HLR2/LLR | 70 | 15 | 3 | 3150 | 12 | 4 |
| HLR2/LLR | 70 | 52 | 3 | 10920 | 40 | 1 |

As shown from the first two columns of Table A2, HLR2 (70%) is more important than HLR1 (30%) and LLR5 is considered to be the most important LLR and accounts for (40%) of the importance of all the LLRs, while LLR (9%) is considered to be the lowest important LLR over all the other LLRs.

Before continuing, it is noted that the VOHCV analysis utilizes the value-oriented approach not only to get the effect of value, but also to get the effect of different other core business values, such as cost, risk, aspect, and impact. Accordingly, the VOHCV analysis enables the product manager to take into account all of the aspects that affect the requirements while selecting the best candidate for product release.

### B. Hybrid-Based Maintainability Impact Analysis (HBMIA)

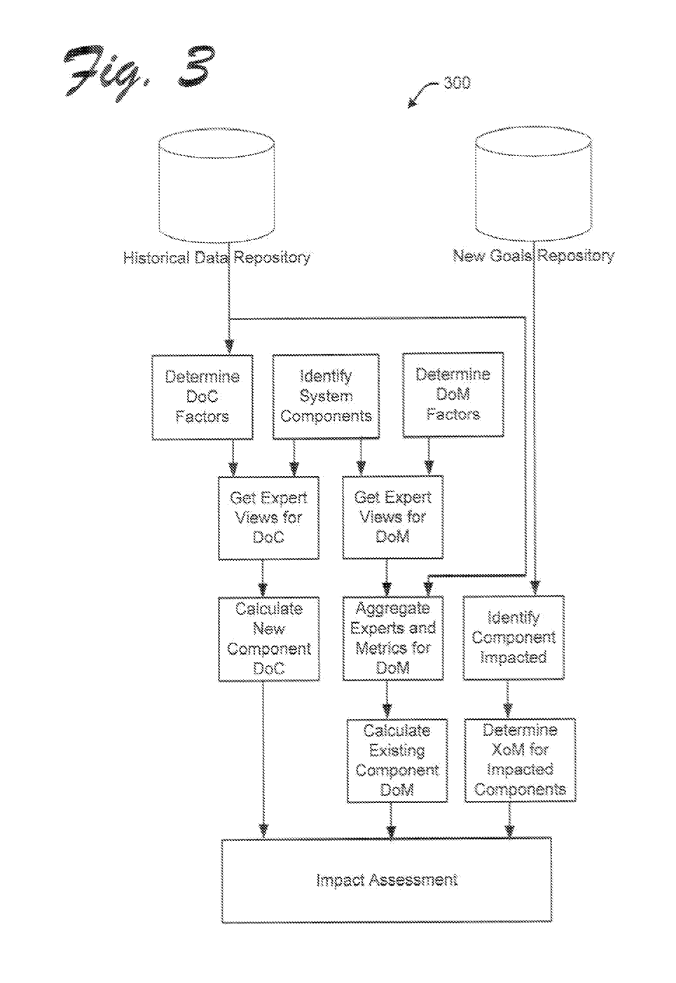

FIG. 3 is a high-level illustration 300 of an exemplary HBMIA analysis. The HBMIA analysis may be better understood in more detail as follows. First, a DoM and DoC are determined for existing and new components, respectively, in addition to the total impact associated with each goal. The following set of parameters may be used with the equations described below:
β: Prioritization vector for DoM/DoC factors of system components with dimension (N×1) for DoM and (M×1) for DoC.
N: Number of DoM factors.
M: Number of DoC factors.
Φ: Prioritization matrix for components with respect to each DoM/DoC factor. The dimension of this matrix may be (Z×N) for DoM and (Z×M) for DoC.
Z: Number of system impacted components.
α: Prioritization vector of the components from the perspective of each expert.
K: Number of experts.
δ: Weighting matrix for the components with respect to experts.
X: Number of experts plus 1.
DoM(c): Difficulty of Modification value for component (c).
DoC(c): Difficulty of Creation value for component (c).
XoM(c,g): eXtent of Modification for component (c) and goal (g).
MSize(c,g): Modified SLOC result from implementing goal (g) into component (c).
Size(c): Total component size.
T: Number of components impacted when implementing goal (g).
L: Number of new components impacted when implementing goal (g).
R: Number of existing components impacted when implementing goal (g).
Impact (g): Total impact of implementing goal (g) in the existing system components.

The DoM/DoC factors are prioritized. This prioritization shows to which extent each factor may impact the DoM/DoC relative to the other factors. This relative importance of the factors may identify the effect of each factor on DoM/DoC from the point of view of each expert, and may also be based on the maturity of these factors data within the system historical metrics. The result is a column vector of β(N)/β(M), where (N) refers to the number of factors affecting (DoM) and (M) refers to number of factors affecting (DoC). The values (e.g., entered by “experts” in the field, or taken from historical metrics) may assign values, e.g., of 1 to 9, such that a value of 1 refers to equal importance, a value of 5 refers to strong importance, and a value of 9 refers to highest importance. The values in between refer to intermediate importance.

The values of the prioritization vector (β) are normalized according to the following equations:

(0≦β(n)≦1)and(0≦β(m)≦1) (EQN 1B)

Σβ(n)=1andΣβ(m)=1 (EQN 2B)

The components are prioritized with respect to each DoM/DoC factor. This prioritization determines how the DoM/DoC for each component may be affected by each DoM/DoC factor. The result is a matrix Φ(Z×N), where (Z) refers to the number of impacted system components. Each entry from this matrix (z,n) may show the relative manner in which each factor in column (n) affects the DoM/DoC of the component in row (z). The values may be entered by “experts” in the field, or taken from historical metrics, and may take values of 1 to 9, where a value of 1 refers to equal importance, a value of 5 refers to strong importance, and a value of 9 refers to extreme importance. The values in between refers to intermediate importance.

The values of the prioritization vector (Φ) are normalized using the following equation:

(0≦Φ)(z,n)≦1)and(0≦Φ(z,m)≦1) (EQN 3B)

The relative priorities of components are determined from the perspective of “experts” in the field, and with respect to historical metrics data for each component. This relative priorities may be determined using the following equation:

α(e,z)=ΣΦ(z,m)×β(m) (EQN 4B)

The result is a (K+1) vector, where (K) refers to the number of experts who contribute in this assessment, plus metric vector results from the historical data for each component.

The components are prioritized with respect to each expert based on his familiarity and experience with each component. Since, values for all components from the historical metrics have the same importance, the values can be assigned the same weights for the metric vector of the components. The result is a matrix δ(z,x), where (X) refers to the number of “experts” in the field, plus 1 for the metric vector. This result may be used only for the (DoM) determination. The (DoC) determination may use δ(z,k) because there is no historical metric contribution. The dimension of the resultant matrix may be δ(Z×X) for (DoM) and δ(Z×K) for (DoC). The values entered by “experts” in the field and/or taken from the historical metrics may be assigned values of 1 to 9, where a value of 1 refers to equal importance, a value of 5 refers to strong importance, and a value of 9 refers to extreme importance.

The values of the prioritization vector (δ) are normalized such that:

(0≦δ(z,x)≦1)and(0≦δ(z,x)≦1) (EQN 5B)

And accordingly:

Σδ(z,x)=1andΣδ(z,k)=1 (EQN 6B)

The “experts” in the field are prioritized with respect to each other. Each “expert” in the field, along with the historical metric data, may be assigned a relative weight to reflect the importance and maturity of each with respect to the developer. The result is a column vector λ(X) for (DoM) and λ(K) for (DoC). The values entered by the developer may take values 1 to 9, where a value of 1 refers to equal importance, a value of 5 refers to strong importance, and a value of 9 refers to extreme importance.

The values of the prioritization vector (δ) are normalized using the following equation:

(0≦λ(x)≦1)and(0≦λ(k)≦1)\ (EQN 7B)

And accordingly:

Σλ(k)=1andΣλ(x)=1 (EQN 8B)

The DoM/DoC values are determined for each component. This may aggregate the different contributions from the “experts” in the field, and historical data based on the assigned weights described above. This may be determined using the following equations:

DoM(c)=Σδ(z,x)Xα(e,z)Xλ(x) (EQN 9B)

DoC(c)=Σδ(z,k)Xα(e,z)Xλ(k) (EQN 10B)

The result from the above equations may satisfy the following inequalities:

(0≦DoM(C)≦1)and(0≦DoC(C)≦1) (EQN 11B)

The extent of modification (XoM) for each component is determined for a goal pair such that XoM(c,g) reflects to which extent component (c) may be impacted/modified by implementing goal (g). This determination may be made only for existing components which are subject to modification. XoM for new components may be equal to 1 based on the above discussion.

XoM(c,g)=MSize(c,g)/Size(c) (EQN 12B)

The list of components impacted by implementing each new goal may be determined. The result is a list of components (T) impacted by implementing goal (g). This is referred to as “Goals-Driven Impact Analysis” (GDIA).

The total impact of implementing goal (g) is determined in the existing product. This impact may be affected by both existing components and new components that are impacted by implementing goal (g):

Impact(g)=Σ(1+XoM(c,g))*DoM(c)+Σ2*DoC(c) (EQN 13B)

The value of 2 in the above equation results from substituting 1 for XoM(c,g) for the new components. Taking into consideration that the total number of existing components (L), plus the total number of new components (R) impacted while implementing goal (g), equals the total number of components (T) which are impacted by implementing goal (g).

### Example B1

In this example, the HBMIA analysis is evaluated for a database that contains data about problems, products, and metrics of a number of software projects. The main objective of the program is to gather, validate, arrange, save and provide software metrics data for the software engineering community. The system includes C++ code. The error data for this code was collected over five years of development and maintenance. The data is analyzed to map it to the class level, so each component refers to a class within KC1. In order to show the practical benefit from the HBMIA analysis, ten new goals G1 to G10 scheduled for implementation as part of the future product maintenance are used, and there are two experts, (Expert_{—}1, and Expert_{—}2) along with the system historical data metrics data.

The components affected by each new goal are shown in Table B1 to Table B13, wherein CM1, CM2, CM3 are existing system components, and CM4, CM5 are new components. The impact values identify goals to be selected for implementation based on the available product resources. The data given in Table B1 indicates that both G1, G3 result in creation of two new components, CM4, CM5, respectively, along with modification of other existing components.

TABLE B1
Components impacted by new goals

| Comp | CM1 | CM2 | CM3 | CM4 | CM5 |
|---|---|---|---|---|---|
| G1 | X | | | | X |
| G | | | X | | |
| G3 | X | X | | X | |
| G4 | X | | | | |
| G5 | X | X | X | | |
| G6 | X | | X | | |
| G | | X | | | |
| G | | | X | | |
| G9 | X | | X | | |
| G | | X | X | | |

TABLE B2
DoM factor historical metric values

| Fact | Size | Compl. | Health | Understd. | Fun |
|---|---|---|---|---|---|
| CM1 | 0.13 | 1 | 0.06 | 1 | 0.07 |
| CM2 | 0.02 | 0.13 | 0.07 | 0.41 | 0.05 |
| CM3 | 0.06 | 0.35 | 0.09 | 0.25 | 0.08 |

TABLE B3
DoM factor values for expert 1

| Factors | Size | Compl. | Health | Unders | Function | Weight |
|---|---|---|---|---|---|---|
| CM1 | 0.3 | 0.6 | 0.44 | 0.27 | 0.23 | 3 |
| CM2 | 0.5 | 0.3 | 0.25 | 0.54 | 0.3 | 4 |
| CM3 | 0.2 | 0.1 | 0.31 | 0.18 | 0.46 | 6 |

TABLE B4
DoM factor values for expert 2

| Factors | Size | Com | Heal | Under | Funct | Weight |
|---|---|---|---|---|---|---|
| CM1 | 0.2 | 0.43 | 0.26 | 0.44 | 0.27 | 5 |
| CM2 | 0.7 | 0.21 | 0.6 | 0.37 | 0.37 | 7 |
| CM3 | 0.1 | 0.36 | 0.14 | 0.12 | 0.12 | 3 |

TABLE B5
DoC factor values for expert 1

| Factors | Size | Com | Criti | Under | Depe | Weight |
|---|---|---|---|---|---|---|
| CM4 | 0.71 | 0.7 | 0.28 | 0.6 | 0.6 | 1 |
| CM5 | 0.29 | 0.3 | 0.72 | 0.4 | 0.4 | 2 |

TABLE B6
DoC factor values for expert 2

| Factors | Size | Com | Criti | Under | Depe | Weight |
|---|---|---|---|---|---|---|
| CM4 | 0.75 | 0.44 | 0.53 | 0.75 | 0.6 | 3 |
| CM5 | 0.25 | 0.56 | 0.47 | 0.25 | 0.4 | 2 |

TABLE B7
DoM factor historical metric weights

| Factor | Size | Complexity | Health | Understandability | Functionality |
|---|---|---|---|---|---|
| Weight | 1 | 1 | 1 | 1 | 1 |

TABLE B8
DoM factor weights for expert 1

| Factor | Size | Complexity | Health | Understandability | Functionality |
|---|---|---|---|---|---|
| Weight | 3 | 5 | 2 | 7 | 1 |

TABLE B9
DoM factor weights for expert 2

| Factor | Size | Complexity | Health | Understandability | Functionality |
|---|---|---|---|---|---|
| Weight | 5 | 2 | 6 | 3 | 4 |

TABLE B10
DoC factor weights for expert 1

| Factor | Size | Complexity | Health | Understandability | Functionality |
|---|---|---|---|---|---|
| Weight | 5 | 6 | 4 | 9 | 3 |

TABLE B11
DoC factor weights for expert 2

| | | | Criti- | | |
|---|---|---|---|---|---|
| Factor | Size | Complexity | cality | Understandabilit | Dependability |
| Weight | 7 | 1 | 3 | 7 | 4 |

TABLE B12
Relative expert's weights

| Expert | Relative Weight |
|---|---|
| Historical | 9 |
| Expert_1 | 3 |
| Expert 2 | 5 |

TABLE B13
XoM data for modified components

| Component | Volume(SLOC) | Modified size |
|---|---|---|
| CM1 | 2789 | 2430 |
| CM2 | 401 | 332 |
| CM3 | 1621 | 1123 |

Following the HBMIA analysis, the total goal impact on the system components is determined as follows. First, the DoM/DoC is determined for all the system components using equations B1 to B11. This yields the results shown in Table B14.

TABLE B14
DoM/DoC component values

| Comoonent | DoM/DoC |
|---|---|
| CM1 | 0.09 |
| CM2 | 0.11 |
| CM3 | 0.05 |
| CM4 | 0.11 |
| CM5 | 0.08 |

The total goal impact is determined based on the goal assignment shown in Table B1, (XoM) data in Table B13, and DoM/DoC determined values shown in Table B14 using equations B12 and B13. Accordingly, G3 is the goal with the greatest impact on the system components; and both G2 and G8 are the goals with the lowest impact on the system components. The goals proposed for implementation should be selected based on the goal impacts on the system components, such that goals with lower impacts are good candidates for implementation by using less resources and having lower costs. Thus calculating the goal impact on system components may be used for better planning activities, such as resource allocation and producing better estimates. This enables the project manger of the product to maintain better control over the product resource and achieve product success.

The HBMIA analysis includes both metric-based and expert-based approaches, while collecting DoM/DoC factor values. The HBMIA analysis considers historical and experts contributions through weights assigned within the organization based on the importance and maturity of the experts and historical data. The HBMIA analysis also receives the benefit of the new components, while determining the total goal impacts to provide higher quality for the determined goal impact, especially when the new goals result in creation of new components. In order to compare the two methodologies, the (DoM) values are determined for the existing components (CM1, CM2, and CM3) without taking the effect of the historical metric data into consideration, resulting in the data shown in Table B15.

TABLE B15
DoM/DoC component values (Saliu approach)

| Component | DoM |
|---|---|
| CM1 | 0.15 |
| CM2 | 0.22 |
| CM3 | 0.08 |

The total goal impact is determined based on the goal assignment shown in Table B1, XoM data in Table B13, and DoM determined values shown in Table B14 using Equations 12B and 13B, resulting in the values shown in Table B16.

TABLE B16
Total goals impact values (Saliu's methodology)

| Goal | Total impact |
|---|---|
| G1 | 0.28 |
| G2 | 0.13 |
| G3 | 0.68 |
| G4 | 0.28 |
| G5 | 0.80 |
| G6 | 0.41 |
| G7 | 0.40 |
| G8 | 0.13 |
| G9 | 0.41 |
| G10 | 0.53 |

Using the HBMIA analysis provides justifiable data based on the system metrics as indicated in Table B2. The data shown in Tables B2, B3 and B4 indicates that DoM values for components CM1, CM2 and CM3 determined from the HBMIA analysis reflect accurate results based on the relative weights, as detailed in Table B12. The HBMIA analysis provides flexibility to better accommodate the business case and provide higher accuracy based on the maturity and availability of the experts.

### C. Value Point (VP)

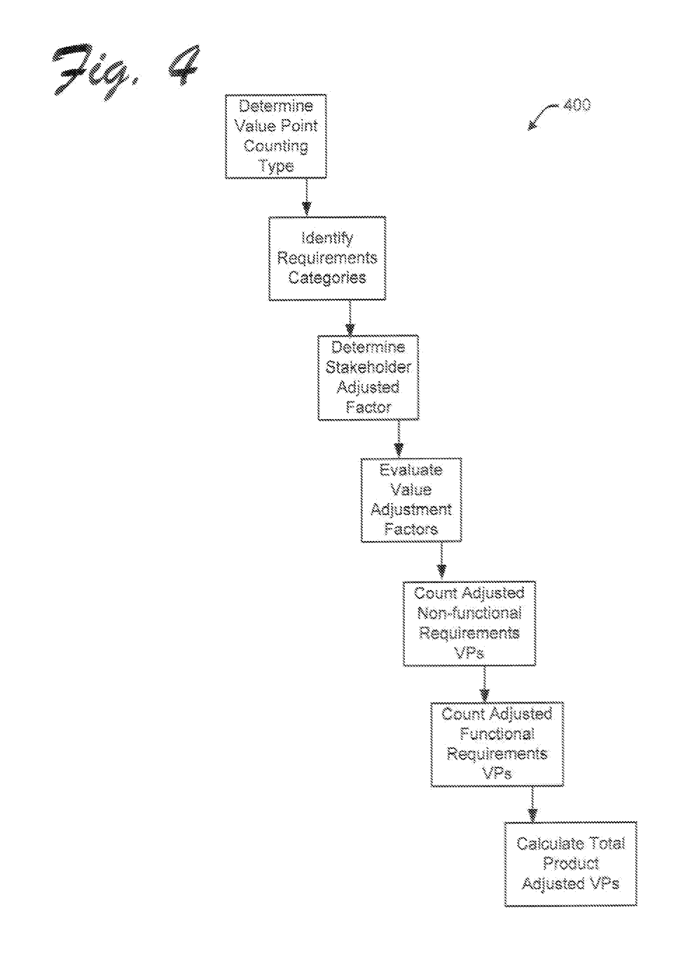

FIG. 4 is a high-level illustration 400 of an exemplary value point counting process architecture. The following discussion illustrates the value point counting process shown in FIG. 4 in more detail.

The value point counting type is determined. There are three counting types based on the nature of the project and value point counting purpose. (1) Enhancement project value point counting refers to the measure of the modification to an existing product that adds, deletes and/or modifies requirements delivered when the project is complete. (2) Development project value point counting refers to that measure of a new developed product with all the requirements provided to the user with the first installation of the product when the project is complete. (3) Application project value point counting refers to that measure for an existing product that is updated every time completion of an enhancement project changes the value point count. This results in a definition of what is to be included in the value point count.

The requirement categories are identified. There are two main categories for product requirements: those which are functional requirements, and those which are non-functional requirements. Each requirement type from the developer requirement types taxonomy may be assigned a corresponding value point measure that reflects the developer nature and how important each type with respect to its customers. The value point corresponding to each requirement type may called Unadjusted Value Point (UVP).

The Stakeholder Adjustment Factor (SAF) is determined, on which each stakeholder may be assigned a weight that reflects how important the stakeholder is to the developer and/or the product.

The Value Adjustment Factors (VAF) is evaluated, on which a value for an adjustment factor to be applied to the (UVP) may be determined. In an exemplary embodiment, the UVP is based on fourteen General Requirement Characteristics (GRC). Each characteristic includes descriptions that help determine the degree of influence of the characteristic. For example, the degree of influence may range on a scale of zero (no influence) to four (strong influence). The fourteen GRCs are summarized below in Table C1.

TABLE C1
GENERAL REQUIREMENT CHARACTERISTICS

| | Influence Degree | | | |
|---|---|---|---|---|
| GSC type | 0 | 1 | 2 | 3 |
| Criticality | Not critical | Less critical | Critical | Highly critical |
| Urgency | Not urgent | Less urgent | Urgent | Highly urgent |
| Stability | Not stable | Less stable | stable | Highly stable |
| Clearness | Not clear | Less clear | clear | Highly clear |
| Feasibility | Not feasible | Less feasible | feasible | Highly feasible |
| Consistency | Not consistent | Less consistent | consistent | Highly consistent |
| Correctness | Not correct | Less correct | correct | Highly correct |
| Completeness | Not complete | Less complete | complete | Highly complete |
| Verifiability | Not verifiable | Less verifiable | verifiable | Highly verifiable |
| ambiguousness | Unambiguous | Less ambiguity | ambiguity | Highly ambiguity |
| Cohesiveness | Not cohesive | Less cohesive | cohesive | Highly cohesive |
| Observability | Not observable | Less observable | observable | Highly observable |
| Understandability | Not understandable | Less understandable | understand | Highly understood |
| Appropriateness | Not appropriate | Less appropriate | appropriate | Highly appropriate |

To determine the value of the adjustment factor, each of the fourteen GRCs are evaluated on a scale from zero (no influence) to four (strong influence) to determine the Degree of Influence corresponding to each characteristic (DI). The degree of influence is summed for all the fourteen GRCs to determine the Total Degree of Influence (TDI), using the following equation.

TDI=ΣDI (EQN 1C)

The Value Adjustment Factor (VAF) taking (TDI) as an argument can be determined using the following equation:

VAF=(TDI*0.01)+0.79 (EQN 2C)

In an exemplary embodiment, the Value Adjustment Factor (VAF) may adjust the Unadjusted Value Point (UVP) by ±21%. Of course, this percentage may be varied based on how important these characteristics are to the developer. For example, if the developer wants the GRCs to be taken as a standard within the product development, then it may increase this percentage value.

The Weighted Adjusted Value Point (WAVP) may be determined for the non functional requirements over all the product stakeholders. This determination may be based on the Unadjusted Value Point value for the requirement (UVP) along with the Value Adjusted Factor (VAF) and Stakeholder Adjusted Factor (SAF) based on the following equation:

WAVP(NFR)=(ΣUVP(NFR)*VAF*SAF(j))/J (EQN 3C)

The Adjusted Value Point (AVP) may be determined for the functional requirements. This may be done using the Unadjusted Value Point value for the requirement (UVP), along with the Value Adjusted Factor (VAF) and Stakeholder Adjusted Factor (SAF) based on the following equation:

WAVP(FR)=(ΣUVP(FR)*VAF*SAF(j))/J (EQN 4C)

The product Total Value Point (TVP) value may be determined for the product requirements according to the following equation:

TAVP=ΣWAVP(NFR)+ΣWAVP(FR) (EQN 5C)

### Example C1

The following example analyzes an industrial case study related to evaluation and implementation of a new software system for physics experiments. The new object oriented system will be available on various platforms (e.g., UNIX and Windows NT), and is also based on software currently available, but would require several extensions to handle specific user requirements of the physics experiments.

The stakeholders in this project have different importance to the organization and to the whole project. This relative importance is controlled by assigning weights described in each stakeholder profile, and used to calculate the Stakeholder Adjusted Value (SAF). There are ten requirements scheduled for the first release that are subjected to value point count. These requirements are subdivided into seven functional requirements and three non-functional requirements.

The product requirements are identified with the corresponding Unadjusted Value Point (UVP) values as assigned by the organization based on the requirement type. The Total degree of Influence (TDI) for each requirement has been calculated based on the Degree of Influence (DI) of the fourteen General Requirement Characteristics (GRCs) using equation 1. The Value Adjusted Factor (VAF) for each requirement is calculated using equation 2, and is shown in Table C2:

TABLE C2
Requirements UVP values

| Requirement | Requirement | U V P | TDI | VAF value |
|---|---|---|---|---|
| R1 | Functional | 150 | 30 | 1.09 |
| R2 | Functional | 100 | 12 | 0.91 |
| R3 | Functional | 390 | 15 | 0.94 |
| R4 | Functional | 230 | 6 | 0.85 |
| R5 | Functional | 200 | 22 | 1.01 |
| R6 | Functional | 150 | 28 | 1.07 |
| R7 | Functional | 280 | 35 | 1.14 |
| R8 | Non | 100 | 9 | 0.88 |
| R9 | Non | 130 | 16 | 0.95 |
| R10 | Non | 150 | 40 | 1.19 |

The Stakeholder Adjusted Factor (SAF) value is identified for the three stakeholders, as assigned by the organization. The stakeholder weight range from zero (lowest weight) to one (highest weight), and is shown in Table C3:

TABLE C3
Requirements UVP values

| Stakeholder | SAF value |
|---|---|
| Stakeholder 1 | 1 |
| Stakeholder 2 | 0.6 |
| Stakeholder 3 | 0.8 |

The Weighted Adjusted Value Point (WAVP) is determined for the functional and non-functional requirements using equations 3 and 4. Then the Total Adjusted Value Point (TAVP) is determined for the product using equation 5, as shown in table C4:

TABLE C4
Requirements WAVP values

| Requirement | WAVP value |
|---|---|
| R1 | 130.8 |
| R2 | 72.8 |
| R3 | 293.28 |
| R4 | 156.4 |
| R5 | 161.6 |
| R6 | 128.4 |
| R7 | 255.36 |
| R8 | 70.4 |
| R9 | 98.8 |
| R10 | 142.8 |

As indicated in Table C3, the product Total Adjusted Value Point (TAVP) from the ten requirements is equal to 1510.64, or “1511 VP.” The TAVP is then compared against the product threshold value. Accordingly, it can be seen that the VP analysis performs well by combining the value aspects that affect product requirements. This provides the organization and product manager with a mechanism to quantify the value gained from the product against the total product budget and use this as a justification for the product feasibility.

### D. Value-Oriented Requirements Management (VORM)

The Value-Oriented Requirements Management (VORM) may be implemented as following. The number of product releases is flexible and can be controlled by the product stakeholders. For example, there may be (n) releases.

The number of requirements to be implemented and distributed over the product release is (m), and may range from R1 to Rm.

A release plan is characterized by a vector (x) of decision variables according to the following equation:

x=(x(1), x(2), . . . , x(m))withx(j)=k (EQN 1D)
if requirement (j) is assigned to release (k).

The requirements dependency is modeled and taken into consideration while planning the release contents. For example, a Type 1 (i) COUPL (j) implementation of requirement (i) requires implementation of requirement (j). If two requirements are in a Type 1 relationship, then (i) should be implemented in the same release as (j). A Type 2 (i) PREC (j) implementation of requirement (i) precedes implementation of requirement (j). If two requirements are in a Type 2 relationship, then (i) should be implemented in the previous release as (j).

A number of parameters affecting the release planning problem may be evaluated for each product release by editing these parameters based on the product conditions, (e.g., product budget, associated risk, impact on existing system components, number of resources, effort in man hours, and value gained from the product releases, to name a few examples). The release plan should satisfy these parameters. These parameters may be expressed as follows. For each release (k), the number of accumulated resources (in FTE or Full Time Equivalent) for the assigned requirements (i) should not exceed the release threshold value for the resources, as expressed by the following equation:

Resource(k,x):=Σresource(i)≦Tesource_Thresold(k)x(i)=k (EQN 2D)

For each release (k), the accumulated estimated risk for the assigned requirements (i) should not exceed release threshold value for the risk value, according to the following equation:

Risk(k,x):=Σrisk(i)≦Risk_Thresold(k)x(i)=k (EQN 3D):

For each release (k), the accumulated cost for the assigned requirements (i) should not exceed the release threshold value for the cost value, according to the following equation:

Cost(k,x):=Σcost(i)≦Cost_Thresold(k)x(i)=k (EQN 4D)

For each release (k), the accumulated estimated effort (in hours) for the assigned requirements (i) should not exceed the release threshold value for the effort value, according to the following equation:

Effort(k,x):=Σeffort(i)≦Effort_Thresold(kx(i)=k (EQN 5D)

For each release (k), the accumulated impact on the existing components result from the assigned requirements (i) should not exceed the release threshold value for the impact value. The impact value for each requirement, is determined using the HBMIA methodology, which may be taken into consideration for the maintenance of an evolving system. But for new system development, the realization effort may be taken directly from the product manager based on the estimated effort supported by the framework features, according to the following equation:

Impact(k,x):=Σimpact(i)≦Impact_Thresold(k)x(i)=k (EQN 6D)

For each release (k), the number of accumulated value points for the assigned requirements (i) should exceed the release threshold value for the value points to be more justified against release budget. The value point for each product release may be assigned by the product manager and agreed upon by the different product stakeholders. The VP for each requirement is determined based on the VP methodology. For example, those releases having a VP less than the threshold value may not be implemented because the invested release budget may be more than the gained value from the release, and this can be determined according to the following equation:

ValuePoint(k,x):=ΣVP(i)≦VP_Thresold(k)x(i)=k (EQN 7D)

Each product stakeholder can enter a perspective regarding each requirement aspect, which may be taken into consideration while prioritizing the requirements as shown in the VOHCV analysis.

By way of example, each of a (q) number of stakeholders range from (S1, S2, . . . Sq) is assigned a weight (Wq). The weights may reflect the importance of each stakeholder to the product in particular and to the whole developer in general. In one embodiment, the weight may be assigned in the range of a value of 1 (referring to lower importance) and a value of 9 (referring to higher importance).

The VOHCV analysis may be used for planning the release contents. As discussed above, the analysis takes into consideration the conflicting perspectives of the different stakeholders with respect to the different criteria effect of each requirement.

The VORM analysis produces five release plans with different objectives. One of the objectives is to increase or even maximize stakeholder satisfaction, minimize inherent risk, minimize impact on the existing system, maximize value and minimize implementation effort based on the inputs from the different stakeholders that is subject to the parameters formulated by equations (1) to (7).

The satisfaction function for each release can be expressed by the following equation:

Sat(x,k)=ΣPriorities(i)x(i)=k (EQN 8D)

The term “Priorities” in Equation 8D refers to the final priority determined from the VOHCV methodology. Thus those requirements may be selected which maximize the satisfaction function by selecting the highest ranked requirements to satisfy the above parameters, which can be expressed by the following equation:

MaximizeSat(x,k) (EQN 9D)

The impact function for each release can be expressed by the following equation:

Impact(x,k)=Σimpact(i)x(i)=k (EQN 10D)

The term “impact” in Equation 10D refers to the impact of the new requirements on the existing system determined from the HBMIA analysis. Thus those requirements which minimize the impact function may be determined by selecting the highest ranked requirements to satisfy the above parameters, as expressed by the following equation:

MinimizeImpact(x,k) (EQN 11D)

The value function for each release can be expressed by the following equation:

Value(x,k)=ΣVP(i)x(i)=k (EQN 12D)

The term “VP” in Equation 12D refers to the Value Point gained from each requirement determined from the VP analysis. Thus, those requirements which maximize the value function may be identified by selecting the highest ranked requirements to satisfy the above parameters.

MaximizeValue(x,k) (EQN 13D)

The risk function for each release can be expressed by the following equation:

Risk(x,k)=Σrisk(i)x(i)=k (EQN 14D)

The term “risk” in Equation 14D refers to the inherent risk associated with each requirement. Thus, those requirements which minimize the risk function may be identified by selecting the highest ranked requirements to satisfy the above parameters according by the following equation:

MinimizeRisk(x,k) (EQN 15D)

The effort function for each release can be expressed by the following equation:

Effort(x,k)=Σeffort(i)x(i)=k (EQN 16D)

The term “effort” in Equation 16D refers to the amount of effort (in hours) for each requirement. Thus, those requirements which minimize the effort function may be identified by selecting the highest ranked requirements to satisfy the above parameters.

MinimizeEffort(x,k) (EQN 17D)

The resulting release plans may satisfy the objectives of all the product stakeholders and maximize their value. Thus the analysis takes the different aspects that affect requirements, competing objectives, inherent parameters and stakeholders conflicting priorities through identifying the release contents, to increase or even maximize stakeholder satisfaction and meet developer goals/expectations.

### Example D1

The following example is provided to illustrate the VORM analysis. In this example, VORM is applied to a telecommunications product, although it is noted that any the VORM analysis is not limited to any type of product. In this example, the product includes 25 requirements in six groups, and the planning process is for the next two annual releases. There are seven stakeholders participating in the evaluation process. They represent different types of developers and their different roles in the development process. Each stakeholder (Sp) gives their judgment with respect to requirement (i). The stakeholder's (S1-7) are summarized as follows.
S1, with weight of importance W1=9
S2 with weight of importance W2=8
S3 with weight of importance W3=6
S4 with weight of importance W4=4
S5 with weight of importance W5=6
S6 with weight of importance W6=3
S7 with weight of importance W7=3

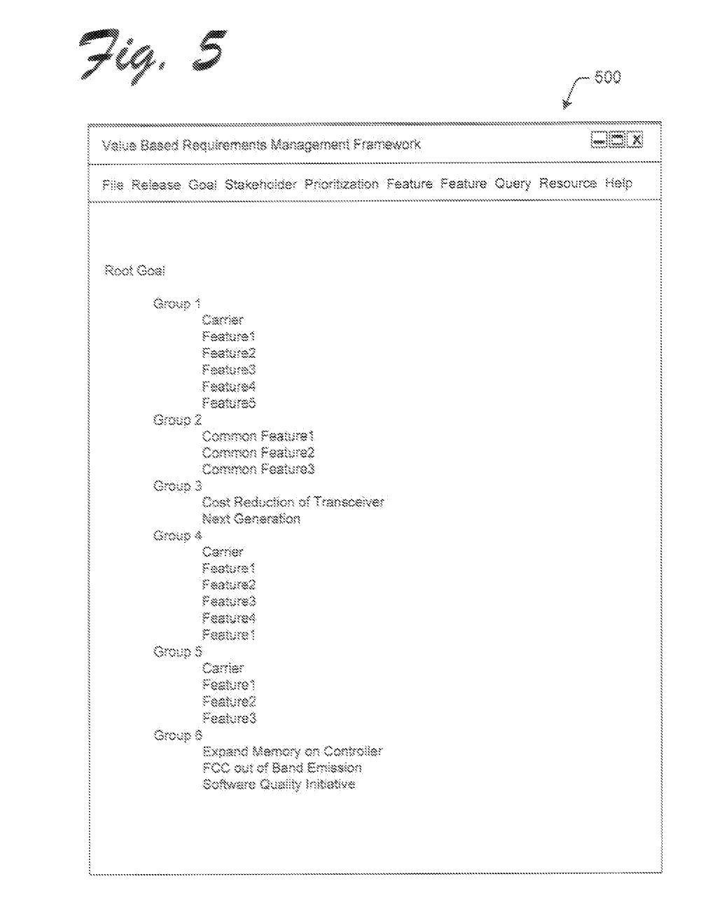

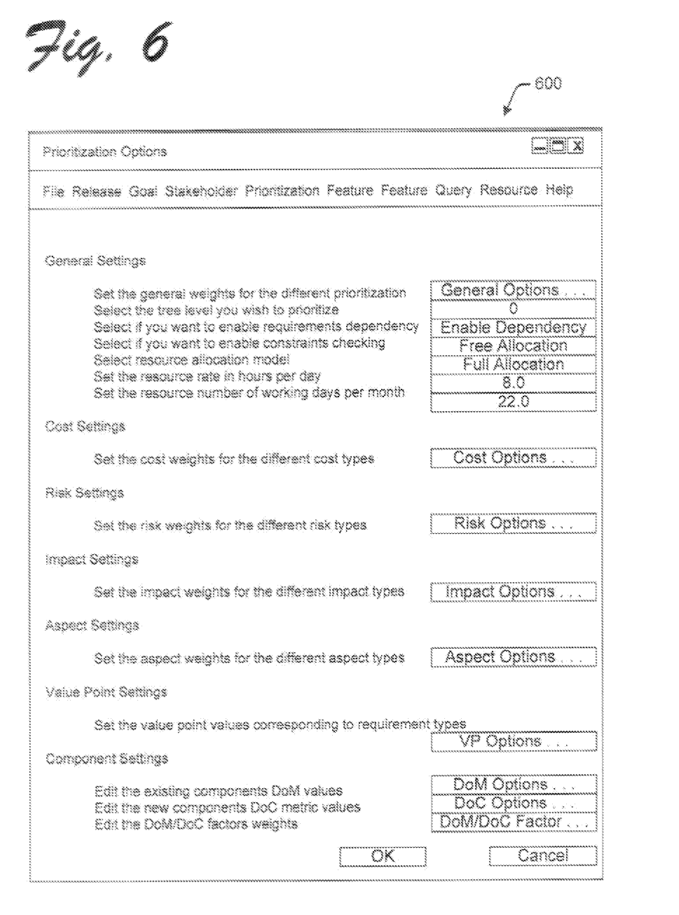

FIG. 5 is an illustration of an exemplary window 500 showing data input to the VORM analysis. The seven stakeholders enter their values and votes for each requirement. The VORM analysis enables the product manager to customize the resulting release plans based on the prioritization options shown in FIG. 6.

FIG. 6 is an illustration of an exemplary window 600 showing edit prioritization options. These options control the different prioritization parameters, such as resource allocation model, dependency enabled option, constraint enabled option, resource number of hours per day, resource number of days per month, general criteria weights for the relative importance of each requirement criteria of risks, market-related aspects, impacts, cost, and importance.

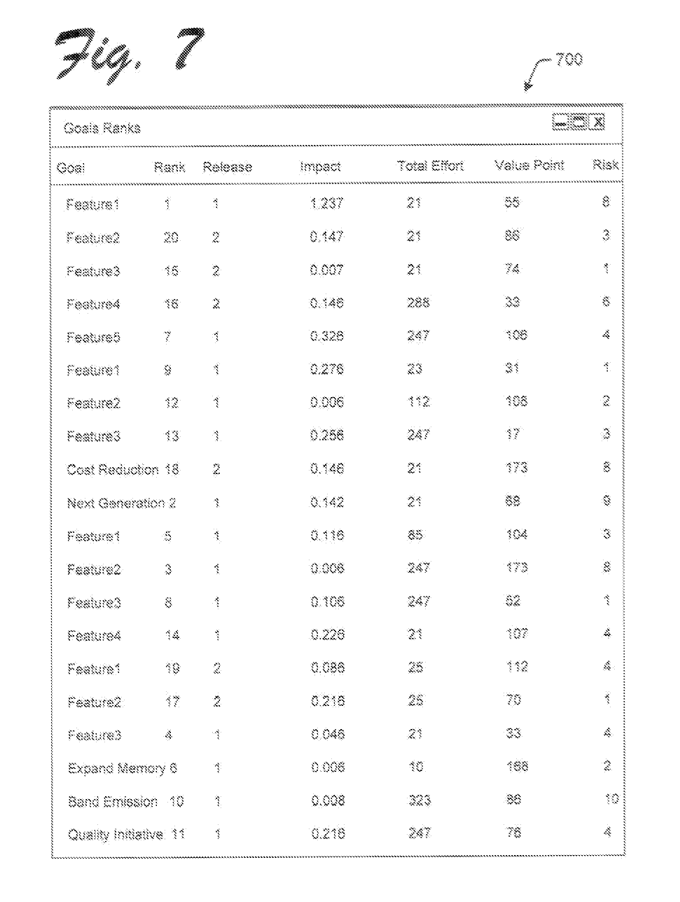

The different release plans produced by the VORM analysis evaluate different objectives. The first release plan objective is to increase or maximize the stakeholders satisfaction based on the input data and different criteria weights as shown in FIG. 7. FIG. 7 is an illustration of an exemplary window showing stakeholder satisfaction. As indicated in the release plan, the different requirements assigned to the two releases indicated in the example data help to increase or maximize stakeholder satisfaction based on their votes and underlying parameters.

The second release plan objective is to minimize impact of the new requirements to be implemented on the existing, system component. An exemplary window similar to that illustrated in FIG. 7 may be used to show the user minimized impact on the system. In the second release plan, the product requirements are distributed over the product releases in a way that reduces or minimizes the impact of implementing these requirements on both existing and new system components. These impacts values are determined using the HBMIA analysis.

The third release plan objective is to minimize release risk. An exemplary window similar to that illustrated in FIG. 7 may be used to show the user minimizing inherent release risk. The product requirements are distributed over product releases in a way that minimize the total release risk associated with implementing the product requirements.

The fourth release plan objective is to minimize the realization effort for either maintaining the system components for existing system or effort required for development of the new system. An exemplary window similar to that illustrated in FIG. 7 may be used to show the user minimizing realization effort. The product requirements are distributed over the product releases in a way that reduces or minimizes the effort associated with implementing the requirements.

The fifth release plan objective is to maximize the value gained from the product requirements through maximizing the VPs gained from implementing the requirements. An exemplary window similar to that illustrated in FIG. 7 may be used to show the user maximizing value gained. The product requirements are distributed over the product releases in a way that increases or maximizes the value gained from implementing the requirements. Accordingly, the product manager may be able to identify those requirements that maximize the value gained from each release.

These different objectives facilitate realizing the different scenarios associated with implementing the requirements. It also enables the product manger to best manage the product requirements to achieve different objectives which maximize the stakeholder's satisfaction.

In addition to the specific embodiments explicitly set forth herein, other aspects and embodiments is apparent to those skilled in the art from consideration of the specification disclosed herein. It is intended that the specification and illustrated embodiments be considered as examples only.

1. A method implemented in program code stored on computer-readable storage code, the method prioritizing requirements for product release, comprising:
receiving customer satisfaction requirements for a pending product release;
receiving product manager input for the pending product release to meet a release schedule on time and on budget;
receiving developer business requirements for the product release to balance the business desires of the developer; and
processing the received customer satisfaction requirements, product manager input, and developer business requirements for the pending product release to output prioritized requirements.

2. The method of claim 1, wherein the product release is a multi-version release of a software product, each version being released at different times and each later-released version including updates and new components from a prior-released version.

3. The method of claim 1, wherein the one or more processing technique is selected to increase value-add requirements for each product release based on the perceived value to the customer.

4. The method of claim 1, wherein the one or more processing technique is selected to increase value-add requirements to the developer.

5. The method of claim 1, wherein the one or more processing technique is selected based on associated anticipated cost, technical risk, relative impact, and other market-related aspects to the developer.

6. The method of claim 1, wherein the one or more processing technique is selected to support flat structures.

7. The method of claim 1, further comprising implementing a VOHCV analysis by:
assigning global weights to core business values;
receiving input from each stakeholder for each business value feature reflecting how a feature affects the requirement from a respective stakeholder perspective;
assigning requirement distribution points assigned to each requirement based on the feature weights and values;
determining the final priorities for the requirements at a level of interest, the determination performed across blocks within a same level to indicate that all requirements located at a specific level are prioritized relative to each other;
determining the final priorities based on the consolidated stakeholders weighted priorities; and
determining the final ranks on the final priority value assigned to each requirement.

8. The method of claim 1, further comprising implementing a HBMIA analysis by:
determining a DoM and DoC for existing and new components, and determining total impact associated with each goal;
prioritizing the DoM/DoC factors to determine to which extent each factor impacts the DoM/DoC relative to the other factors;
normalizing a prioritization vector (β);
prioritizing components with respect to each DoM/DoC factor to determine how the DoM/DoC for each component is affected by each DoM/DoC factor;
normalizing the values of a prioritization vector (Φ);
determining the relative priorities of components based on “experts” in the field and historical metrics data for each component;
prioritizing components with respect to each expert based on familiarity and experience with each component;
normalizing the values of a prioritization vector (δ);
prioritizing the experts in the field with respect to each other by assigned a relative weight to reflect the importance and maturity of each with respect to the developer;
prioritizing the values of the prioritization vector (δ);
determining the DoM/DoC values for each component by aggregating the different contributions from the experts in the field, and historical data based on the assigned weights;
determining the extent of modification (XoM) for each component;
compiling a list of components impacted by implementing each new goal; and
determining total impact of implementing goal (g) in the existing product.

9. The method of claim 1, further comprising implementing a VP analysis by:
determining a value point counting type;
identifying requirement categories;
determining a Stakeholder Adjustment Factor (SAF), wherein each stakeholder is assigned a weight reflecting how important the stakeholder is to the developer and/or the product;
evaluating a Value Adjustment Factors (VAF), wherein a value for an adjustment factor to be applied to the (UVP) is determined.
determining the value of the adjustment factor;
determining a Value Adjustment Factor (VAF);
determining a Weighted Adjusted Value Point (WAVP) for non-functional requirements over all the stakeholders;
determining an Adjusted Value Point (AVP) for functional requirements; and
determining product Total Value Point (TVP) value for product requirements.

10. A computer program product including program executable to prioritize requirements for product release, the program code executing to:
receive satisfaction requirements input by a customer for a pending product release;
receive product release information input by a program manager to meet a release schedule on time and on budget;
receive business requirements input by a developer for the product release;
process the satisfaction requirements, input by the product manager, and business requirements; and
output prioritized requirements to increase or maximize value for the customer and the developer and increase overall satisfaction with the product when the product is released.

11. The computer program product of claim 10, further comprising implementing a VOHCV in program code by:
assigning global weights to core business values;
receiving input from each stakeholder for each business value feature reflecting how a feature affects the requirement from a respective stakeholder perspective;
assigning requirement distribution points assigned to each requirement based on the feature weights and values;
determining the final priorities for the requirements at a level of interest, the determination performed across blocks within a same level to indicate that all requirements located at a specific level are prioritized relative to each other;
determining the final priorities based on the consolidated stakeholders weighted priorities; and
determining the final ranks on the final priority value assigned to each requirement.

12. The computer program product of claim 10, further comprising implementing a HBMIA in program code by:
determining a DoM and DoC for existing and new components, and determining total impact associated with each goal;
prioritizing the DoM/DoC factors to determine to which extent each factor impacts the DoM/DoC relative to the other factors;
normalizing a prioritization vector (β);
prioritizing components with respect to each DoM/DoC factor to determine how the DoM/DoC for each component is affected by each DoM/DoC factor;
normalizing the values of a prioritization vector (Φ);
determining the relative priorities of components based on “experts” in the field and historical metrics data for each component;
prioritizing components with respect to each expert based on familiarity and experience with each component;
normalizing the values of a prioritization vector (δ);
prioritizing the experts in the field with respect to each other by assigned a relative weight to reflect the importance and maturity of each with respect to the developer;
prioritizing the values of the prioritization vector (δ);
determining the DoM/DoC values for each component by aggregating the different contributions from the experts in the field, and historical data based on the assigned weights;
determining the extent of modification (XoM) for each component;
compiling a list of components impacted by implementing each new goal; and
determining total impact of implementing goal (g) in the existing product.

13. The computer program product of claim 10, further comprising implementing a VP analysis in program code by:
determining a value point counting type;
identifying requirement categories;
determining a Stakeholder Adjustment Factor (SAF), wherein each stakeholder is assigned a weight reflecting how important the stakeholder is to the developer and/or the product;
evaluating a Value Adjustment Factors (VAF), wherein a value for an adjustment factor to be applied to the (UVP) is determined;
determining the value of the adjustment factor;
determining a Value Adjustment Factor (VAF);
determining a Weighted Adjusted Value Point, (WAVP) for non-functional requirements over all the stakeholders;
determining an Adjusted Value Point (AVP) for functional requirements; and
determining product Total Value Point (TVP) value for product requirements.

14. The computer program product of claim 10, further comprising implementing a VORM analysis in program code by:
defining a number of product releases (n) based on stakeholders.
determine a number (m) of requirements to be implemented and distributed over the product releases (R1 to Rm);
characterizing a release plan is characterized by a vector (x) of decision variables;
modeling requirements dependency and taking into consideration while planning the release contents;
evaluating a number of parameters affecting a release planning problem for each product release by editing the parameters based on product conditions
using the prioritization analysis for planning the release contents taking into consideration any conflicting perspectives of different stakeholders with respect to different criteria affecting each requirement; and
outputting different release plans with different objectives.

15. A system for prioritizing requirements for product release, comprising:
a computer architecture configured to:
receive customer satisfaction requirements for a pending product release;
receiving product manager input for the pending product release to meet a release schedule on time and on budget; and
receiving developer business requirements for the product release to balance the business desires of the developer;
computer readable storage configured to store program code to process the received customer satisfaction requirements, product manager input, and developer business requirements for the pending product release; and
an output device configured to output prioritized requirements and increased or maximized value for the customer and the developer to increase overall satisfaction with the product when the product is released based on the at least one analysis.
